(19) United States
(12) Patent Application Publication
(10) Pub. No.: US 2010/0064262 A1
(43) Pub. Date: Mar. 11, 2010

(54) Optical multi-touch method of window interface

(75) Inventor: Chih-Chien Liao, Taipei (TW)

Correspondence Address: BACON & THOMAS, PLLC, 4th Floor, 625 Slaters Lane, Alexandria, VA, 22314-1176, US

(73) Assignee: KYE SYSTEMS CORP., Taipei (TW)

(21) Appl. No.: 12/379,898

(22) Filed: Mar. 4, 2009

(30) Foreign Application Priority Data
Sep. 5, 2008 (TW) 097134278

(51) Int. Cl. G06F 3/033; G06F 3/042

(52) U.S. Cl. 715/863; 345/175

(57) ABSTRACT

An optical multi-touch method of a window interface is adapted to control an object in the window interface. The method includes providing a first optical sensing window to obtain a first tracking signal and providing a second optical sensing window to obtain a second tracking signal; resolving the first tracking signal to determine a first displacement direction and resolving the second tracking signal to determine a second displacement direction; and controlling a motion of the object in the window interface according to a relative relation between the first displacement direction and the second displacement direction.

### CROSS-REFERENCE TO RELATED APPLICATIONS

This non-provisional application claims priority under 35 U.S.C. § 119(a) on Patent Application No(s). 097134278 filed in Taiwan, R.O.C. on Sep. 5, 2008 the entire contents of which are hereby incorporated by reference.

### BACKGROUND OF THE INVENTION

1. Field of Invention

The present invention relates to a control method of a window interface, and more particularly to an optical multi-touch method of a window interface.

2. Related Art

A computer input device generally refers to a hardware device capable of inputting a coordinate displacement signal into a computer device (for example, a personal computer (PC), a notebook computer, or a personal digital assistant (PDA)). There are a variety of available computer input devices, including mouse, trackball device, touchpad, handwriting pad, and joystick. The mouse is not only capable of inputting a coordinate displacement signal into a computer device according to the movement of a user, but also provided with a wheel for controlling a longitudinal or lateral scrollbar of a window interface. A micro-switch is further disposed below the wheel, so that the user can issue an acknowledgement instruction by pressing the wheel. Therefore, in the application of the window interface, the mouse has become the most widely applied man-machine interface.

However, in the application of the man-machine interface, a multi-touch technology is increasingly favored by users, as the multi-touch technology enables the users to have a more intuitive and convenient operating experience when operating a window interface. A projected capacitive technology is one of the technologies for achieving multi-touch.

In the projected capacitive technology, a single-layer or multi-layer patterned indium tin oxide (ITO) layer is adopted to form a column/row staggered sensing element matrix. Therefore, in the life cycle of the sensing element matrix, a precise touch position can be obtained without aligning, and a multi-touch operation may also be achieved by using a thick cover layer. However, the difficulty in design is also increased. For wiring, generally, a projected capacitive cellular phone panel is at least required to be connected with 15 wires, and the wiring becomes more complex with an increasingly higher demand of the sensing resolution, which also leads to an increase in the difficulty in fabrication. In addition, as the sensing element matrix is disposed in the same dimensional space, the sensing area of the sensing element matrix is compressed, and the reduced area may degrade the sensitivity of the matrix. Besides, the closely laid wires may easily cause capacitance leakage, and especially the temperature and humidity may easily affect the sensing accuracy. Therefore, it is the problem in urgent need of solutions to provide a convenient multi-touch method of a window interface.

### SUMMARY OF THE INVENTION

Accordingly, the present invention is an optical multi-touch method of a window interface, in which a computer input device having two optical sensing windows is employed to achieve the optical multi-touch function, so as to facilitate the operation of the window interface.

Therefore, an optical multi-touch method of a window interface of the present invention is adapted to control an object in the window interface. The method comprises the steps of: providing a first optical sensing window to obtain a first tracking signal and providing a second optical sensing window to obtain a second tracking signal; resolving the first tracking signal to determine a first displacement direction and resolving the second tracking signal to determine a second displacement direction; and controlling a motion of the object in the window interface according to a relative relation between the first displacement direction and the second displacement direction.

In the optical multi-touch method of a window interface, two optical sensing windows are disposed on the computer input device to respectively obtain a tracking signal corresponding to an operation of a user, and determine displacement directions according to the tracking signals, so as to correspondingly control a motion of the object in the window interface. Besides, it is unnecessary to form a column/row staggered sensing element matrix in the optical sensing windows of the present invention, so that the circuit architecture is relatively simple. In addition, the optical sensing is not easily affected by temperature or humidity, and thus a desired sensing accuracy is achieved.

### BRIEF DESCRIPTION OF THE DRAWINGS

The present invention will become more fully understood from the detailed description given herein below for illustration only, and thus are not limitative of the present invention, and wherein:

FIG. 1 is a schematic view of a computer system according to the present invention;

FIG. 2A is a flow chart of a method according to a first embodiment of the present invention;

FIG. 2B is a flow chart of a method according to a second embodiment of the present invention;

FIG. 3A is a schematic view illustrating an operation of applying the present invention in a portable electronic device such as a cellular phone or PDA;

FIG. 3B is a schematic view illustrating another operation of applying the present invention in a portable electronic device such as a cellular phone or PDA;

FIG. 3C is a schematic view illustrating another operation of applying the present invention in a portable electronic device such as a cellular phone or PDA;

FIG. 3D is a schematic view illustrating another operation of applying the present invention in a portable electronic device such as a cellular phone or PDA;

FIG. 4A is a schematic view illustrating an operation of the optical multi-touch according to the present invention;

FIG. 4B is a schematic view illustrating another operation of the optical multi-touch according to the present invention;

FIG. 4C is a schematic view illustrating another operation of the optical multi-touch according to the present invention;

FIG. 4D is a schematic view illustrating another operation of the optical multi-touch according to the present invention;

FIG. 4E is a schematic view illustrating another operation of the optical multi-touch according to the present invention;

FIG. 4F is a schematic view illustrating another operation of the optical multi-touch according to the present invention;

FIG. 4G is a schematic view illustrating another operation of the optical multi-touch according to the present invention; and

FIG. 4H is a schematic view illustrating another operation of the optical multi-touch according to the present invention.

### DETAILED DESCRIPTION OF THE INVENTION

The computer input device provided by the present invention comprises, but not limited to, a computer peripheral input device such as a mouse, trackball, touchpad, or game controller, and can be built inside an electronic device having a window interface such as a notebook computer, personal digital assistant (PDA), digital frame, or cellular phone for providing users with functions related to operations. However, the accompanying drawings are provided for reference and illustration only, and not intended to limit the present invention. In the following description of the implementation, a mouse serves as a computer input device and a desk-top computer serves as a computer device, which is considered as the most preferred embodiment of the present invention.

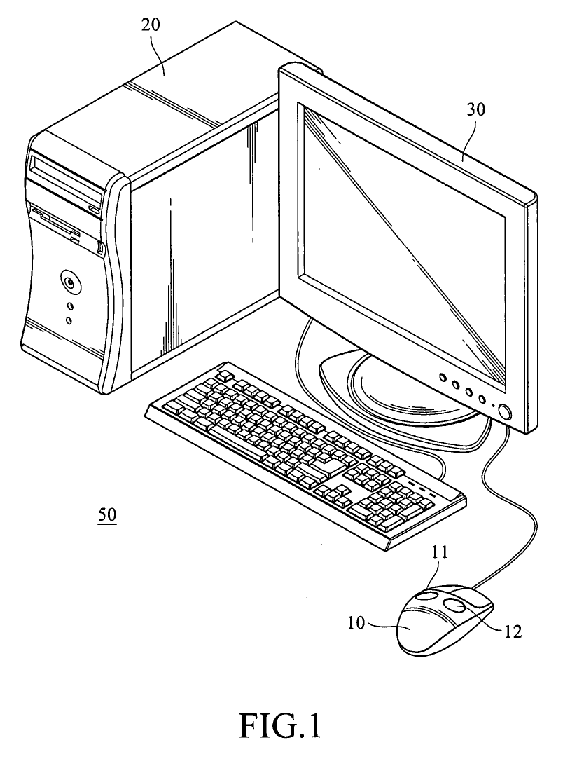

FIG. 1 is a schematic view of a computer system according to the present invention. Referring to FIG. 1, the computer system 50 comprises a computer input device 10 and a computer device 20. According to an input processing method of a computer input device provided by the present invention, the computer input device 10 is a mouse, and the computer device 20 is a desk-top computer. In the prior art, the mouse may be signal-connected to the desk-top computer in a wired or wireless manner, and moves on a plane. The displacement of the mouse on the plane is calculated in a mechanical or optical manner, and is then converted into a displacement signal and transmitted to the desk-top computer, so as to control a cursor on a window interface (for example, Windows interface system) of the desk-top computer to move on the window interface. Moreover, the mouse is provided with a first optical sensing window 11 and a second optical sensing window 12. The first optical sensing window 11 or the second optical sensing window 12 can replace the wheel of a conventional mouse. When a user touches the first optical sensing window 11 and the second optical sensing window 12 with fingers on one hand or on both hands or with other objects, the first optical sensing window 11 and the second optical sensing window 12 respectively capture images of the fingers or objects to generate at least one corresponding control signal. The first optical sensing window 11 and the second optical sensing window 12 may at least be image detection sensors, for example, charged coupled devices (CCDs) or complementary metal-oxide semiconductors (CMOSs) for detecting image changes caused by the movement of a finger. The technical feature about how to detect finger movement can be further referred to in U.S. Pat. No. 7,298,362 filed by applicant. If the two sensing windows are adopted radiation detection sensors for detecting physical property changes of light after refraction, U.S. Pat. No. 6,872,931 can be referred to.

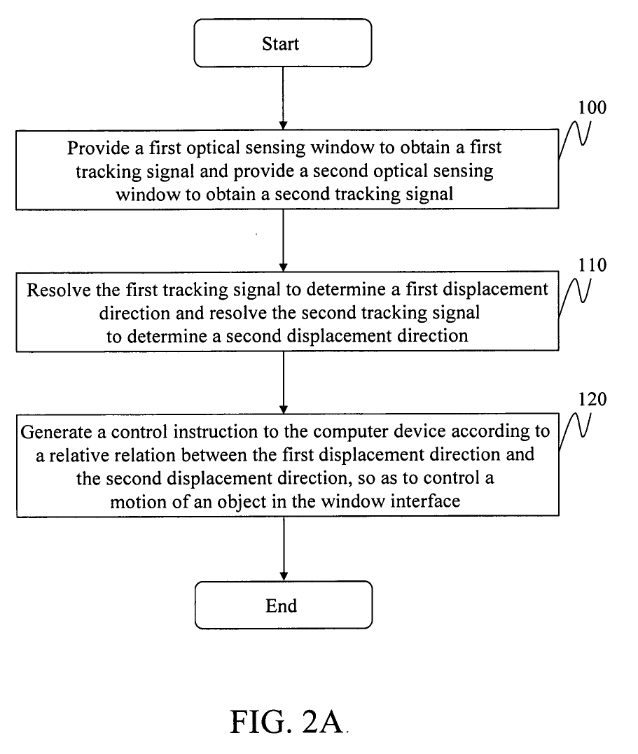

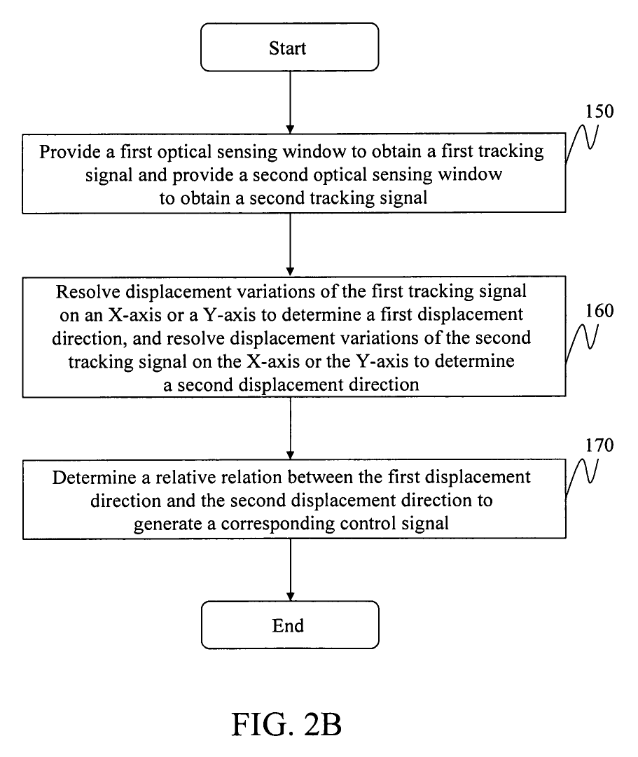

FIG. 2A is a flow chart of a method according to a first embodiment of the present invention. Referring to FIG. 2A, the optical multi-touch method of a window interface provided by the present invention is adapted to control an object in a window interface of a computer through a computer input device. The object may be, for example, a picture, a mouse pointer, or a picture selected by the mouse pointer, and the number of the object may be more than one. The optical multi-touch method of a window interface comprises the following steps.

First, a first optical sensing window is provided to obtain a first tracking signal, and a second optical sensing window is provided to obtain a second tracking signal (Step 100). The first optical sensing window and the second optical sensing window may be disposed on the same side surface or on different side surfaces of the computer input device, so as to enable a user to operate by placing a finger or another object on the first optical sensing window or the second optical sensing window. A micro-processor (not shown) in the computer input device is adapted to obtain the first tracking signal according to origin and endpoint coordinates of the finger when contacting the first optical sensing window, and obtain the second tracking signal according to origin and endpoint coordinates of the finger when contacting the second optical sensing window. In addition, a computer input device having more than two (for example, three) optical sensing windows may also be provided in Step 100.

Next, the computer input device resolves the first tracking signal obtained through the first optical sensing window to determine a first displacement direction, and resolves the second tracking signal obtained through the second optical sensing window to determine a second displacement direction (Step 110). The first displacement direction is determined according to variations of coordinates of the first tracking signal on an X-axis and a Y-axis, and a direction corresponding to the movement of the finger (i.e., the first displacement direction) as well as displacements of the signal on the X-axis and Y-axis can be obtained according to a distribution relation between origin and endpoint coordinates of the first tracking signal in a two-dimensional coordinate system. The second displacement direction is determined according to variations of coordinates of the second tracking signal on the X-axis and the Y-axis, and a direction corresponding to the movement of the finger (i.e., the second displacement direction) as well as displacements of the signal on the X-axis and Y-axis can be obtained according to a distribution relation between origin and endpoint coordinates of the second tracking signal in a two-dimensional coordinate system.

The computer input device generates a corresponding control signal or control instruction to the computer device according to a relative relation between the first displacement direction and the second displacement direction, and for example, the control signal is used for controlling a motion of the object in the window interface (Step 120). The type of the control instruction to be generated to the computer device can be determined according to a comparison table as shown in Table 1 below.

TABLE 1

| | | Variations | Variations | |
|---|---|---|---|---|
| Variations on | Variations on | on the | on the | |
| the X-axis | the Y-axis | X-axis in the | Y-axis in the | |
| in the first | in the first | second | second | |
| displacement | displacement | displacement | displacement | Control |
| direction | direction | direction | direction | instruction |
| 0 | Increased | 0 | Increased | Move |
| | | | | upward |
| 0 | Reduced | 0 | Reduced | Move |
| | | | | downward |
| Reduced | 0 | Reduced | 0 | Move |
| | | | | leftward |
| Increased | 0 | Increased | 0 | Move |
| | | | | rightward |
| 0 | Increased | 0 | Reduced | Rotate |
| | | | | leftward |
| 0 | Reduced | 0 | Increased | Rotate |
| | | | | rightward |
| Increased | 0 | Reduced | 0 | Scale up |
| Reduced | 0 | Increased | 0 | Scale |
| | | | | down |

In Step 120, the motion of the object may be, for example, “Page up” or “Page down” of a page turning function; moving up, down, left, right, top left, bottom left, top right, or bottom right, or rotating left or right; scaling up or down in size; or executing other user-defined operating instructions (for example, performing a playback, stop, or mute function of a multimedia player).

FIG. 2B is a flow chart of a method according to a second embodiment of the present invention. Referring to FIG. 2B, the optical multi-touch method of a window interface provided by the present invention is adapted to control an object in a window interface of a computer through a computer input device. The object may be, for example, a picture, a mouse pointer, or a picture selected by the mouse pointer, and the number of the object may be more than one. The optical multi-touch method of a window interface comprises the following steps.

First, a first optical sensing window is provided to obtain a first tracking signal, and a second optical sensing window is provided to obtain a second tracking signal (Step 150). The first optical sensing window and the second optical sensing window may be disposed on the same side surface or on different side surfaces of the computer input device, so as to enable a user to operate by placing a finger or another object on the first optical sensing window or the second optical sensing window. A micro-processor (not shown) in the computer input device is adapted to obtain the first tracking signal according to origin and endpoint coordinates of the finger when contacting the first optical sensing window, and obtain the second tracking signal according to origin and endpoint coordinates of the finger when contacting the second optical sensing window. In addition, a computer input device having more than two (for example, three) optical sensing windows may also be provided in Step 150.

Next, the computer input device resolves displacement variations of the first tracking signal on an X-axis or a Y-axis to determine a first displacement direction, and resolves displacement variations of the second tracking signal on the X-axis or the Y-axis to determine a second displacement direction (Step 160). The first displacement direction as well as displacements of the signal on the X-axis and Y-axis in the first displacement direction can be determined according to a distribution relation between origin and endpoint coordinates of the first tracking signal in a two-dimensional coordinate system. The second displacement direction as well as displacements of the signal on the X-axis and Y-axis in the second displacement direction can be determined according to a distribution relation between origin and endpoint coordinates of the second tracking signal in a two-dimensional coordinate system.

A relative relation between the first displacement direction and the second displacement direction is determined to generate a corresponding control signal (Step 170), and the control signal is used for controlling display variations of an image on a display or operations of a multimedia player. The type of the control instruction to be generated to the computer device can be determined according to a comparison table as shown in Table 1 above.

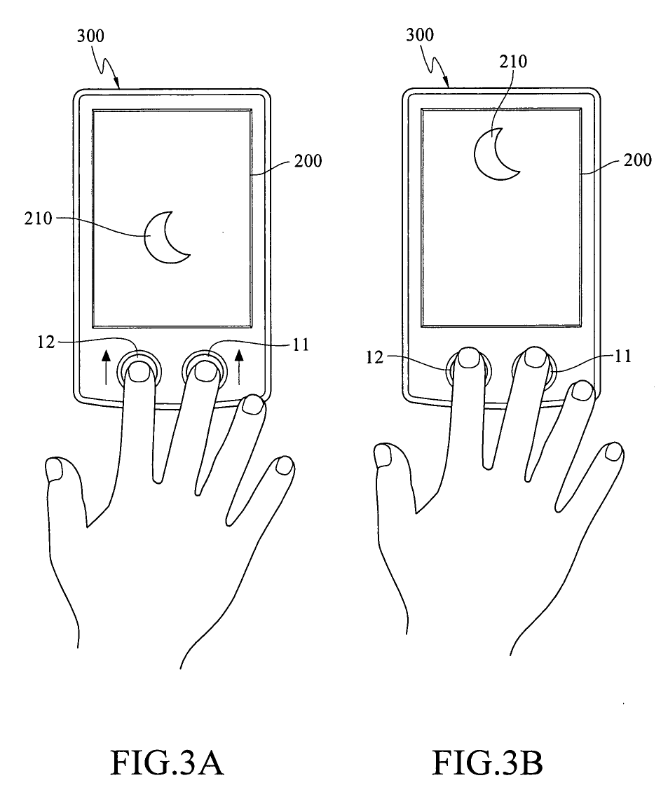

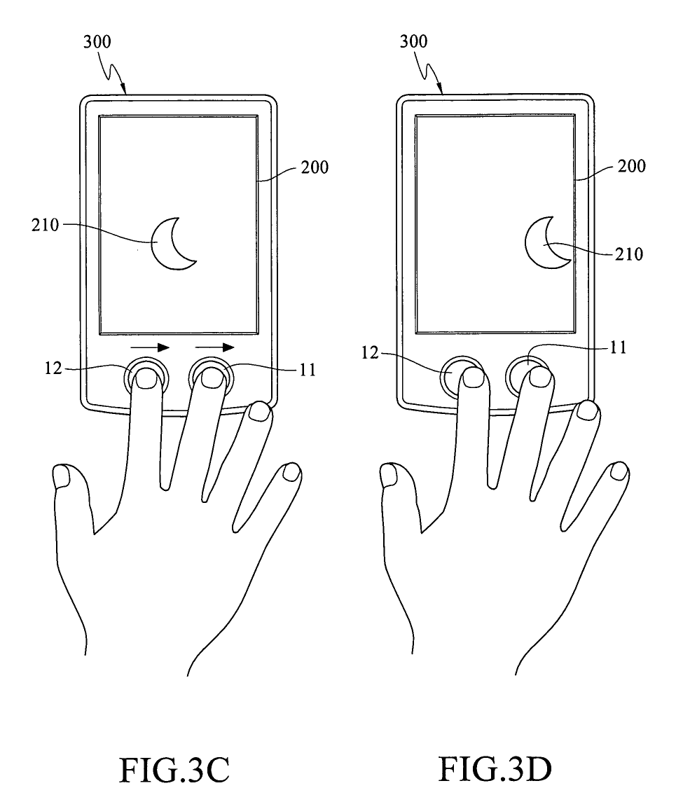

FIGS. 3A, 3B, 3C and 3D are schematic views illustrating operations of applying the present invention in a portable electronic device such as a cellular phone or PDA. Referring to FIGS. 3A, 3B, 3C and 3D, a user operates on a first optical sensing window 11 and a second optical sensing window 12 of a portable electronic device 300, so as to control a motion of a display image, i.e., an object 210 in a window interface 200 (or a motion of any display image on a display 30). The user can operate on the first optical sensing window 11 and the second optical sensing window 12 with fingers on one hand or on both hands or with other objects.

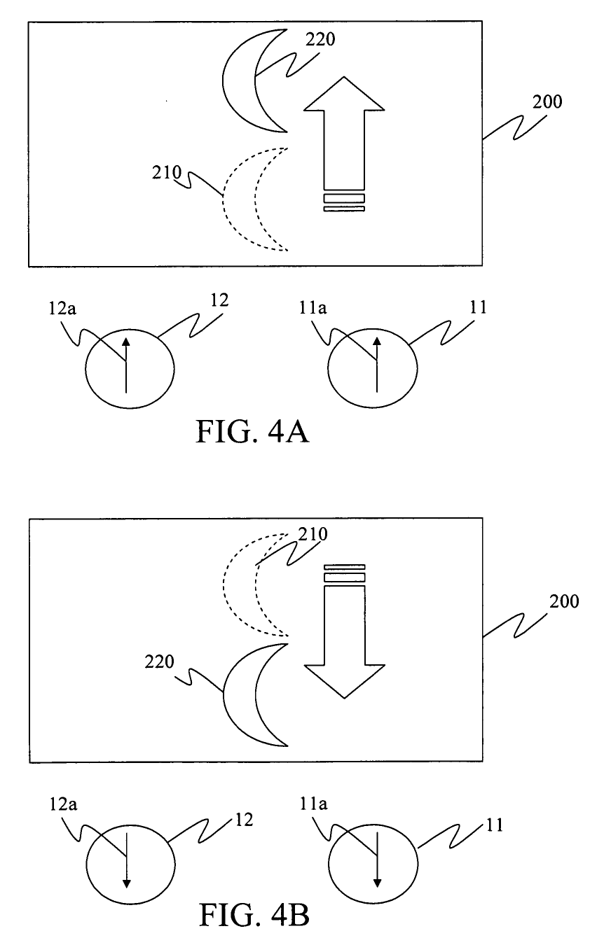

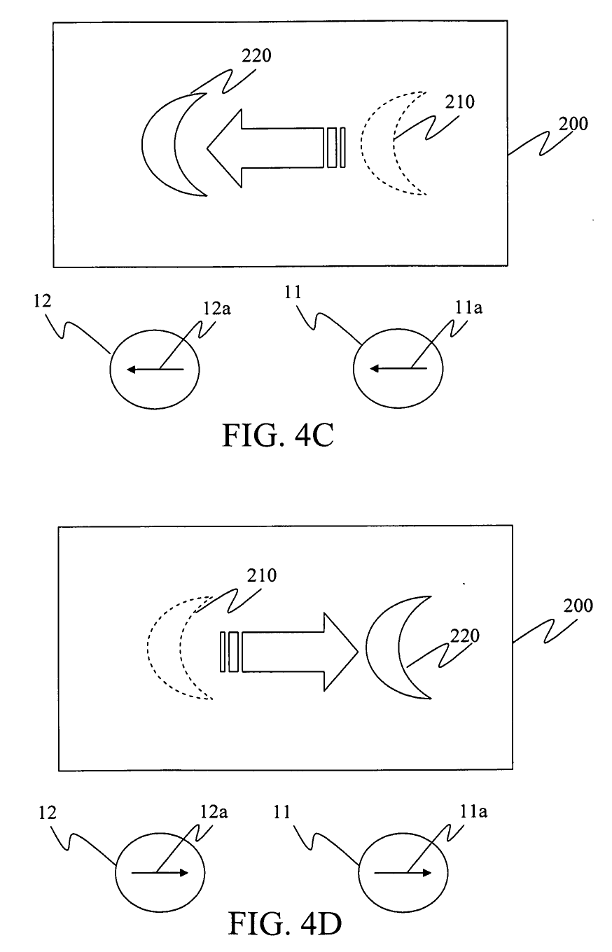

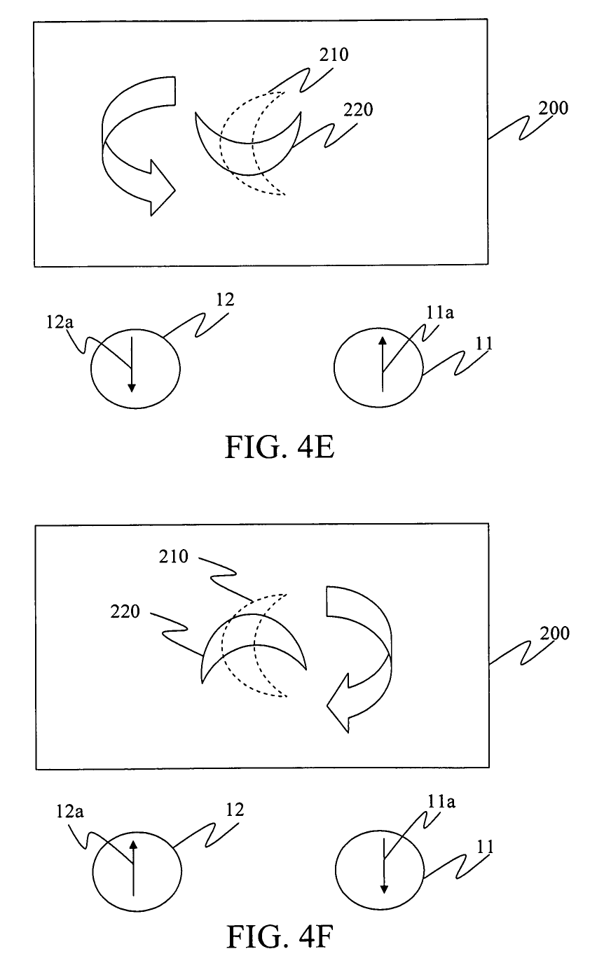

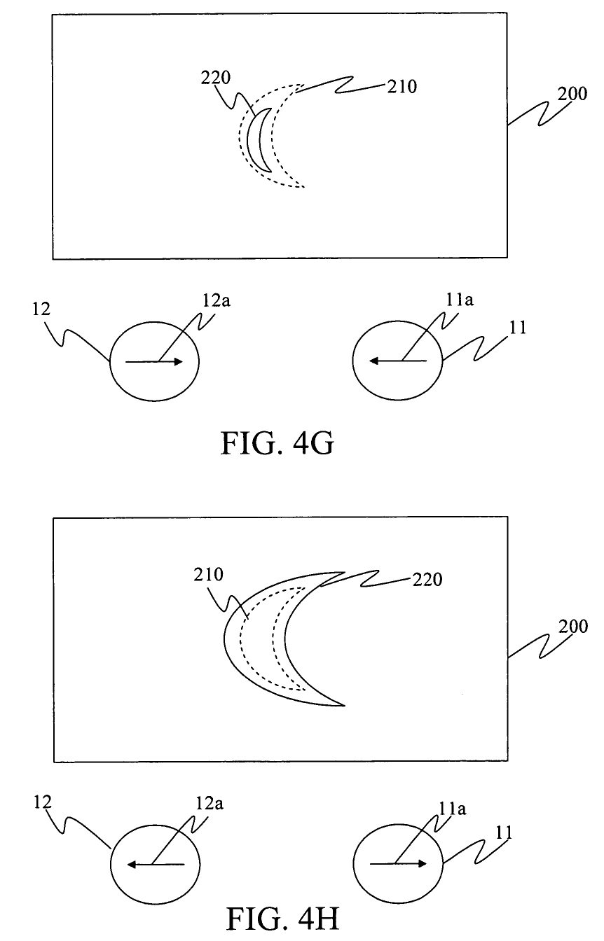

FIG. 4A is a schematic view illustrating an operation of the optical multi-touch according to the present invention. Referring to FIG. 4A, first, when the user moves upward on the first optical sensing window 11, the computer input device determines a first displacement direction 11a according to the first tracking signal. When the user moves upward on the second optical sensing window 12, the computer input device determines a second displacement direction 12a according to the second tracking signal. Next, the computer input device generates a control signal to the computer device according to a relative relation between the first displacement direction 11a and the second displacement direction 12a, so as to control the motion of the object 210. As the displacement coordinates on the Y-axis in the first displacement direction and the second displacement direction are both increased, the object 210 in the window interface 200 moves upward to the position of an object 220.

FIG. 4B is a schematic view illustrating another operation of the optical multi-touch according to the present invention. Referring to FIG. 4B, first, when the user moves downward on the first optical sensing window 11, the computer input device determines a first displacement direction 11a according to the first tracking signal. When the user moves downward on the second optical sensing window 12, the computer input device determines a second displacement direction 12a according to the second tracking signal. Next, the computer input device generates a control signal to the computer device according to a relative relation between the first displacement direction 11a and the second displacement direction 12a, so as to control the motion of the object 210. As the displacement coordinates on the Y-axis in the first displacement direction and the second displacement direction are both reduced, the object 210 in the window interface 200 moves downward to the position of an object 220.

FIG. 4C is a schematic view illustrating another operation of the optical multi-touch according to the present invention. Referring to FIG. 4C, first, when the user moves leftward on the first optical sensing window 11, the computer input device determines a first displacement direction 11a according to the first tracking signal. When the user moves leftward on the second optical sensing window 12, the computer input device determines a second displacement direction 12a according to the second tracking signal. Next, the computer input device generates a control signal to the computer device according to a relative relation between the first displacement direction 11a and the second displacement direction 12a, so as to control the motion of the object 210. As the displacement coordinates on the X-axis in the first displacement direction and the second displacement direction are both reduced, the object 210 in the window interface 200 moves leftward to the position of an object 220.

FIG. 4D is a schematic view illustrating another operation of the optical multi-touch according to the present invention. Referring to FIG. 4D, first, when the user moves rightward on the first optical sensing window 11, the computer input device determines a first displacement direction 11a according to the first tracking signal. When the user moves rightward on the second optical sensing window 12, the computer input device determines a second displacement direction 12a according to the second tracking signal. Next, the computer input device generates a control signal to the computer device according to a relative relation between the first displacement direction 11a and the second displacement direction 12a, so as to control the motion of the object 210. As the displacement coordinates on the X-axis in the first displacement direction and the second displacement direction are both increased, the object 210 in the window interface 200 moves rightward to the position of an object 220.

FIG. 4E is a schematic view illustrating another operation of the optical multi-touch according to the present invention. Referring to FIG. 4E, first, when the user moves upward on the first optical sensing window 11, the computer input device determines a first displacement direction 11a according to the first tracking signal. When the user moves downward on the second optical sensing window 12, the computer input device determines a second displacement direction 12a according to the second tracking signal. Next, the computer input device generates a control signal to the computer device according to a relative relation between the first displacement direction 11a and the second displacement direction 12a, so as to control the motion of the object 210. As the displacement coordinates on the Y-axis in the first displacement direction 11a are increased, and the displacement coordinates on the Y-axis in the second displacement direction 12a are reduced, the object 210 in the window interface 200 rotates leftward to the position of an object 220.

FIG. 4F is a schematic view illustrating another operation of the optical multi-touch according to the present invention. Referring to FIG. 4F, first, when the user moves downward on the first optical sensing window 11, the computer input device determines a first displacement direction 11a according to the first tracking signal. When the user moves upward on the second optical sensing window 12, the computer input device determines a second displacement direction 12a according to the second tracking signal. Next, the computer input device generates a control signal to the computer device according to a relative relation between the first displacement direction 11a and the second displacement direction 12a, so as to control the motion of the object 210. As the displacement coordinates on the Y-axis in the first displacement direction 11a are reduced, and the displacement coordinates on the Y-axis in the second displacement direction 12a are increased, the object 210 in the window interface 200 rotates rightward to the position of an object 220.

FIG. 4G is a schematic view illustrating another operation of the optical multi-touch according to the present invention. Referring to FIG. 4G, first, when the user moves leftward on the first optical sensing window 11, the computer input device determines a first displacement direction 11a according to the first tracking signal. When the user moves rightward on the second optical sensing window 12, the computer input device determines a second displacement direction 12a according to the second tracking signal. Next, the computer input device generates a control signal to the computer device according to a relative relation between the first displacement direction 11a and the second displacement direction 12a, so as to control the motion of the object 210. As the displacement coordinates on the X-axis in the first displacement direction 11a are reduced, and the displacement coordinates on the X-axis in the second displacement direction 12a are increased, the object 210 in the window interface 200 is scaled down to the size of an object 220.

FIG. 4H is a schematic view illustrating another operation of the optical multi-touch according to the present invention. Referring to FIG. 4H, first, when the user moves rightward on the first optical sensing window 11, the computer input device determines a first displacement direction 11a according to the first tracking signal. When the user moves leftward on the second optical sensing window 12, the computer input device determines a second displacement direction 12a according to the second tracking signal. Next, the computer input device generates a control signal to the computer device according to a relative relation between the first displacement direction 11a and the second displacement direction 12a, so as to control the motion of the object 210. As the displacement coordinates on the X-axis in the first displacement direction 11a are increased, and the displacement coordinates on the X-axis in the second displacement direction 12a are reduced, the object 210 in the window interface 200 is scaled up to the size of an object 220.

In addition, the optical multi-touch method of the present invention can further control the moving distance, rotation angle, and the scale-up/down ratio of the object according to the displacements of the first tracking signal and the second tracking signal on the X-axis and Y-axis.

It should be noted that, when the first optical sensing window 11 and the second optical sensing window 12 are small enough in size and also arranged close enough to each other, the user can cover the optical sensing windows 11 and 12 with one finger at the same time, thus achieving the same effect. For example, when the finger moves upward, upward displacement signals are triggered at the same time, as shown in FIG. 4A; when the finger moves downward, downward displacement signals are triggered at the same time, as shown in FIG. 4B; when the finger moves leftward or rightward, leftward or rightward displacement signals are triggered at the same time, as shown in FIG. 4C or 4D; and if the finger rotates anticlockwise or clockwise, an upward displacement signal and a downward displacement signal are triggered at the same time, as shown in FIG. 4E or 4F. However, in this implementation, the modes in FIGS. 4G and 4H cannot be achieved.

To sum up, in the optical multi-touch method of a window interface provided by the present invention, two optical sensing windows are disposed on the computer input device to respectively obtain a tracking signal corresponding to an operation of a user, and determine displacement directions according to the tracking signals, so as to correspondingly control a motion of the object in the window interface. Besides, it is unnecessary to form a column/row staggered sensing element matrix in the optical sensing windows of the present invention, so that the circuit architecture is relatively simple. In addition, the optical sensing is not easily affected by temperature or humidity, and thus a desired sensing accuracy is achieved.

What is claimed is:

1. An optical multi-touch method of a window interface, adapted to control an object in the window interface, the method comprising:
providing a first optical sensing window to obtain a first tracking signal and providing a second optical sensing window to obtain a second tracking signal;
resolving the first tracking signal to determine a first displacement direction and resolving the second tracking signal to determine a second displacement direction; and
controlling a motion of the object in the window interface according to a relative relation between the first displacement direction and the second displacement direction.

2. The optical multi-touch method of a window interface according to claim 1, wherein the first displacement direction is determined according to variations of coordinates of the first tracking signal on an X-axis and a Y-axis, and the second displacement direction is determined according to variations of coordinates of the second tracking signal on the X-axis and the Y-axis.

3. The optical multi-touch method of a window interface according to claim 1, wherein when the displacement coordinates on the Y-axis in the first displacement direction and the second displacement direction are increased, the object is controlled to move in an upward direction.

4. The optical multi-touch method of a window interface according to claim 1, wherein when the displacement coordinates on the Y-axis in the first displacement direction and the second displacement direction are reduced, the object is controlled to move in a downward direction.

5. The optical multi-touch method of a window interface according to claim 1, wherein when the displacement coordinates on the X-axis in the first displacement direction and the second displacement direction are reduced, the object is controlled to move in a leftward direction.

6. The optical multi-touch method of a window interface according to claim 1, wherein when the displacement coordinates on the X-axis in the first displacement direction and the second displacement direction are increased, the object is controlled to move in a rightward direction.

7. The optical multi-touch method of a window interface according to claim 1, wherein when the displacement coordinates on the Y-axis in the first displacement direction are increased, and the displacement coordinates on the Y-axis in the second displacement direction are reduced, the object is controlled to rotate in a leftward direction.

8. The optical multi-touch method of a window interface according to claim 1, wherein when the displacement coordinates on the Y-axis in the first displacement direction are reduced, and the displacement coordinates on the Y-axis in the second displacement direction are increased, the object is controlled to rotate in a rightward direction.

9. The optical multi-touch method of a window interface according to claim 1, wherein when the displacement coordinates on the X-axis in the first displacement direction are reduced, and the displacement coordinates on the X-axis in the second displacement direction are increased, the object is scaled down in size.

10. The optical multi-touch method of a window interface according to claim 1, wherein when the displacement coordinates on the X-axis in the first displacement direction are increased, and the displacement coordinates on the X-axis in the second displacement direction are reduced, the object is scaled up in size.

11. An optical multi-touch method of a window interface, at least comprising:
providing a first optical sensing window to obtain a first tracking signal and providing a second optical sensing window to obtain a second tracking signal;
resolving displacement variations of the first tracking signal on an X-axis or a Y-axis to determine a first displacement direction, and resolving displacement variations of the second tracking signal on the X-axis or the Y-axis to determine a second displacement direction; and
determining a relative relation between the first displacement direction and the second displacement direction to generate a corresponding control signal.

12. The optical multi-touch method according to claim 11, wherein the control signal is used for controlling display variations of an image on a display or operations of a multimedia player.
